(19) United States
(12) Patent Application Publication
(10) Pub. No.: US 2023/0171360 A1
(43) Pub. Date: Jun. 1, 2023

(54) METHODS AND SYSTEMS FOR ENHANCING CONTENT OF A DOCUMENT BASED ON VISUAL LENS POWER OF A USER

(71) Applicant: Xerox Corporation, Norwalk, CT (US)

(72) Inventors: Srinivasarao Bindana, Kakinada (IN); Jagadeeswaran Lakshmipathy, Chennai (IN); Shalini Kondore, Old-AIwal (IN)

(73) Assignee: Xerox Corporation, Norwalk, CT (US)

(21) Appl. No.: 17/456,715

(22) Filed: Nov. 29, 2021

(51) Int. Cl. H04N 1/387; G06F 40/109; H04N 1/00

(52) U.S. Cl. CPC H04N 1/3875; G06F 40/109; H04N 1/00469; H04N 1/00472

(57) ABSTRACT

The present disclosure discloses methods and systems for enhancing content of a document according to visual lens power of a user. In the method, a document from a user is received for a pre-defined operation such as printing, scanning, copying, or the like. Then, a selection of visually enhanced content option is received from the user. Based on the selection of the option, a profile of the user is checked for visual lens power information of the user. Based on the check, the content of the document is automatically enlarged according to the visual lens power information of the user. Subsequently, an output document including the enhanced content is generated based on the pre-defined operation such that the enhanced content is comfortably read by the user.

### TECHNICAL FIELD

The present disclosure relates to the field of content enhancement in a document. More specifically, the disclosure relates to enhancing content of a document according to visual lens power information of a user.

### BACKGROUND

When a user submits a document for printing, scanning, or copying, he may wish to enhance content such as text of the document for various reasons. For example, a user may not have his spectacles while reading a printed document. Therefore, the user may wish to copy the document such that the text size of the content in the document can be increased and he can read the document comfortably even without spectacles. In another example, a user may want to print a document with increased text size. Sometimes, a user may wish to scan and email a document to another user such that the text size of the content in the scanned document is compatible with his eyesight. In one more example, a student who wishes to print a textbook may want to increase the text size of the content so that he can read the textbook comfortably and/or without the need of any visual aid.

Currently, the only option available with the user is to make changes to the text size of the document before submitting for printing, copying, faxing, and/or scanning. But, in this option, the user is required to perform multiple steps. For example, if the document is in a non-editable format (e.g., Portable Document Format), the user is first required to convert the document into an editable format. Then, the user needs to increase the text size of the content manually. In most of these cases, the user increases the text size randomly and the increased text size may not be compatible to the eyesight of the user. Moreover, making changes to the document requires significant time and effort, and the user may not have the required time and patience to perform all these steps. In some cases, the user may not even have the required skills to make text size and format related changes in the document.

Additionally, there can be scenarios where the user has already submitted the document for printing or scanning and wants to enhance content of the submitted document. While the user can enhance the text in visual displays for better readability, but there are no options available to enhance the text automatically in the print/copy/scan outputs which can help the user to read the content comfortably. In this view, there is a need for systems and methods for content enhancement in a way that requires minimal effort and time of the user.

### SUMMARY

According to aspects illustrated herein, a method for enhancing content of a document according to a visual lens power information of a user is disclosed. In the method, a document from a user is received for a pre-defined operation such as printing, scanning, or copying. Then, a selection of visually enhanced content option is received from the user. Based on the selection of the option, a profile of the user is checked for visual lens power information of the user. Based on the check, the content of the document is automatically enlarged/enhanced according to the visual lens power information of the user. Subsequently, an output document including the enhanced content is generated based on the pre-defined operation such that the enhanced content is comfortably read by the user.

According to further aspects illustrated herein, a multi-function device for enhancing content of a document according to visual lens power of a user is disclosed. The multi-function device includes a receiver for receiving a document from a user for a pre-defined operation. The multi-function device further includes a user interface for receiving a selection of visually enhanced content option from the user. Based on the selection, a controller checks whether a user profile includes visual lens power information of the user. Based on the check, the controller automatically enlarges the content of the document according to the visual lens power information of the user. Subsequently, the controller requests one of the following—a print engine, a scanner or a copier to generate an output document including the enhanced content such that the enhanced content is comfortable for the user.

According to another aspect illustrated herein, a system for enhancing content of a document according to visual lens power information is disclosed. The system includes a server for receiving a document along with a selection of visually enhanced content option. Based on this, the server checks if profile of a user includes visual lens power information of the user. Based on the check, the server automatically enlarges content of the document according to the visual lens power information of the user. Subsequently, the server sends an output document including the enhanced content to a multi-function device for further processing. The multi-function device is communicatively coupled to the server, for outputting an output document including the enhanced content such that the enhanced content is comfortably read by the user.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIGS. 1A and 1B show exemplary environments in which various embodiments of the disclosure can be practiced.

FIG. 2A is a block diagram illustrating various components of a multi-function device, in accordance with an embodiment of the present disclosure.

FIG. 2B is a system including a multi-function device and a server, in accordance with an embodiment of the present disclosure.

FIGS. 3A-3E show exemplary snapshots of user interfaces including visual enhanced content option, in accordance with implementation of the present disclosure.

FIGS. 4A-4E show exemplary snapshots of user interfaces including visual enhanced content option in a copy workflow, in accordance with implementation of the present disclosure.

FIGS. 5A-5E show exemplary snapshots of user interfaces including visual enhanced content option in a scan-to-email workflow, in accordance with embodiments of the present disclosure.

FIGS. 6A-6E show exemplary snapshots of user interfaces including visual enhanced content option in a scan workflow, in accordance with embodiments of the present disclosure.

FIGS. 7A-7B show exemplary snapshots of user interfaces including visual enhanced content option in a print driver, in accordance with embodiments of the present disclosure.

FIGS. 8A-8B show exemplary implementation of the present disclosure.

FIGS. 9A-9B show method flowcharts for enhancing content of a document, in accordance with embodiments of the present disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a single device or a combination of multiple devices, to perform one or more functions such as, but not limited to, printing, imaging, scanning, copying, and so forth. The multi-function device may include software, hardware, firmware, or a combination thereof. In context of the current disclosure, the multi-function device enhances content of a document according to visual lens power information of a user. The content be enhanced when the document is submitted by the user for a pre-defined operation such as printing, scanning, copying or the like. For example, the multi-function device enlarges text of the document as per the visual lens power or eyesight of the user while printing the document. As a result, the printed document includes the enlarged text that is comfortable for the user to read without any visual aid (e.g., spectacles, contact lenses). In context of the current disclosure, the multi-function device includes a visually enhanced content option that allows the user to enhance the content of the document submitted at the multi-function device. The content of the document can be enhanced based on visual lens power information of the user or other users.

The term “document” refers to a document having one or more pages including content. The content can be in the form of text, image, graphics, or a combination thereof. The document can be in physical form, such as printed on paper. If the document is submitted for scanning or copying, the document submitted is in the physical form. The document can be in an electronic form or a virtual form. For example, if the document is submitted for printing, the document is in the virtual form. The document submitted for a pre-defined operation can be referred to as an input document.

The term “pre-defined operation” can be any imaging operation to be performed by the multi-function device. Few non-limiting examples of the pre-defined operation can be printing, scanning, copying, or the like.

The term “visual lens power” refers to the power of a visual lens such as eye lenses, lenses of a spectacle, or contact lenses. In humans, the normal eye lenses have a power of 60 diopters (i.e., 60 DS). For some reasons, if this power of eye lenses is changed, the correction is done by wearing a visual aid such as spectacles or contact lenses that changes the power back to 60 DS. For instance, if a person has a right eye lens power of 62 DS, he wears a spectacle or contact lenses with −2 DS power so that after summing up the two powers the normal power of 60 DS is obtained. This is how a normal eyesight or vision in maintained.

The term “visual lens power information” of the user refers to visual lens power of his left eye and/or right eye. The visual lens power can be defined in diopters, other known or later developed formats. The visual lens power information can include any readable content sizes that the user prefers.

The term “enhancing content” refers to enhancement of content in the document such that the user can comfortably read the enhanced content i.e., without stressing his eyes, without requiring any visual aid or the enhanced content suits the visual lens power of the user. The enhancement of content may include increasing font size of the text, enlarging images or graphics in the document, etc. such that the user can read content of the document comfortably without requiring a visual aid such as spectacles or contact lenses. The content enhancement may include enhancing entire content of the document i.e., all pages of the document or may include enhancing partial content of the document i.e., one or more pages of the document, half of the document, more than half of the document, specific pages of the document, and so on.

The term “user profile” refers to a profile that includes information related to the user. The user profile includes information such as username, email address, visual lens power, font size, font type, text size or other relevant information for implementing the present disclosure In context of the current disclosure, the user profile stores the visual lens power information of the user or readable text sizes according to the visual lens power such that the content of the document is automatically enhanced when the user prints, copies, or scans the document at the multi-function device.

The “output document” refers to a document resulted after enhancing the content of the document based on the pre-defined operation. For example, if the document is submitted for printing, then the output document is a printed document with enhanced content. In another example, if the document is submitted for scanning, then the output document is a scanned document/output with the enhanced content. Similarly, if the document is submitted for copying, then the output document is a copied document with the enhanced content.

The term “public document” refers to a document that is for use by user other than the user discussed above (i.e., the user who submits the document for printing, scanning, or copying). In other words, the other user can be the user who receives the printed document, scanned document, or the copied version of the document from the user. The content enhancement of such public document is done based on the visual lens power information of the other user who is going to receive the output document. In such cases, the user is required to input the visual lens power information of the other user. The term “personal document” refers to a document that is a personal document of the use or is for personal use by the user. In such cases, the content enhancement is performed based on the visual lens power information of the user.

The term “keywords” refer to one or more keywords input by the user for content enhancement. The keywords may be in the form of text, numeric, alphanumeric, image, graphics, or a combination of these. In context of the current disclosure, content of the document is enhanced based on the keywords input by the user. For example, the multi-function device searches for one or more pages having matching keywords and based on searching, the multi-function device enhances content of the pages having keywords as input by the user.

The term “matching” refers to the one or more keywords that are either exactly same or related to the one or more keywords input by the user. For example, if a keyword input by the user is ‘drone’, some of the matching keywords can be ‘drones’, ‘unmanned vehicle’, ‘UAVs’, ‘aerial vehicles’ and so on. In context of the present disclosure, when the user inputs one or more keywords for content enhancement, one or more pages including the matching keywords are identified. Based on the identified pages, content of the pages including the matching keywords is enhanced. The matching keywords can be acronyms, synonyms, substitutions, short forms, or keywords that are associated to the input keywords, e.g., short names related to the input keyword, substitutions, or shortcuts set forth by the user.

The term “computing device” refers to a device that a user typically uses for giving print commands and other purposes. Examples of the computing device include, but are not limited to, a personal computer, a desktop, a laptop, a mobile phone, a tablet, a Personal Digital Assistant (PDA), a smart-phone or any other device capable of data communication. The computing device includes a print driver application that allows the user to submit one or more documents for printing. In context of the present disclosure, the print driver application includes an option to visually enhance content of the document such that the document when submitted at the multi-function device is enhanced as per user's visual lens power information. The content of the document is enhanced such that the user can comfortably read the document without visual aid.

The term “user” refers to include a user who submits the document at the multi-function device for a pre-defined operation such as printing, scanning, or copying. The “other user” refers to a guest user or a user in some relation to the user who submits the document for printing, for example.

### Overview

Currently, when a user wishes to visually enhance content of a document, he is required to change font size of text, enlarge images, etc. in the document before submitting the document for printing, scanning, or copying at a multi-function device. In scenarios, where the user wishes to scan, print, or copy the document as per his visual lens power or other user, he is required to make edits in the document. The present disclosure is provided to address such challenges such the user is not required to do make any edits or content enhancement before/after submission to the multi-function device.

The present disclosure discloses methods and systems for enhancing content of a document such that enhanced content of the document can be comfortably read, seen, or viewed by a user. The content of the document is enhanced according to visual lens power information of the user who submits the document or visual lens power information of other/guest user. The methods and systems allow the user to enhance content of the user for any document submitted at a multi-function device for printing, scanning, or copying. To this end, the methods and systems incorporate a visually enhanced content option at devices such as a multi-function device, a scanner, a copier, a print driver, or any other similar devices. Based on the selection of the option by the user, the methods and systems obtain visual lens power information of the user. Based on the obtained visual lens power information, content of the document is enhanced according to the visual lens power information of the user.

### Exemplary Environment

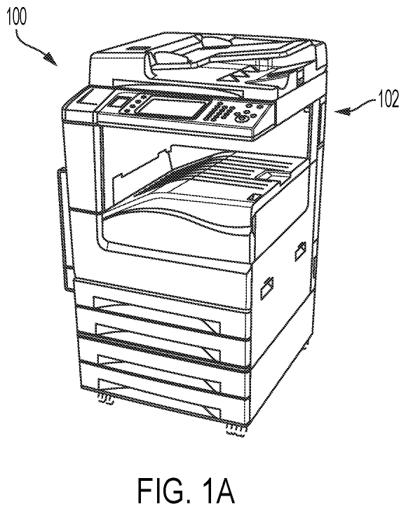

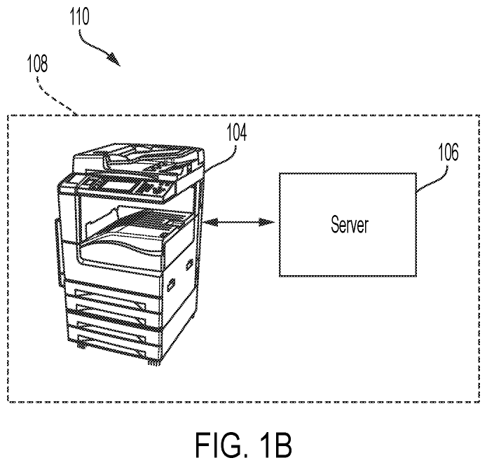

FIG. 1A shows an exemplary environment 100 in which various embodiments of the disclosure can be practiced. The environment 100 includes a multi-function device 102 capable of performing one or more functions such as printing, copying, scanning, faxing, or a combination thereof. Although, the environment 100 is shown to include the multi-function device 102, but the environment 100 can include a scanner, a copier, a printer, multi-functional printer, a multi-functional peripheral or any device having imaging functionalities and/or content enhancement functionality.

In the context of present disclosure, the multi-function device 102 provides content enhancement functionality for enhancing content of a document submitted at the multi-function device 102 for a pre-defined operation such as for printing, scanning, copying and so on. To this end, the multi-function device 102 includes a visually enhanced content option that allows the user to enhance the content of the document submitted at the multi-function device 102. The content of the document is enhanced according to visual lens power information of the user or guest user. The content of the document is enhanced such that the enhanced content is comfortable for the user to read even without any visual aid such as spectacles. For simplicity, the disclosure is discussed with respect to printing scenarios, but it is understood that the disclosure is equally applicable to copying or scanning scenarios. For purpose of discussion, the content is enhanced according to the visual lens power information of the user (i.e., the user who submits the document at the multi-function device 102) but the disclosure can be implemented for enhancing content of the document according to visual lens power information of the other/guest user.

In operation, the user submits the document for printing. The document can be submitted via a computing device of the user. But the document for printing can be selected directly at the multi-function device 102 such as a memory of the multi-function device 102. In other examples, the document for printing can be submitted via a portable storage device that can be plugged to the multi-function device 102. In further examples, the document for printing can be submitted via a cloud location, a server location or other location accessible by/at the multi-function device 102. The document may include content in the form of image, graphics, text, or a combination thereof. The document submitted can be in any format as known or later developed formats.

Post receiving the document, the multi-function device 102 provides a visually enhanced content option to the user via a user interface. Post selection of the visually enhanced content option, the multi-function device 102 obtains the visual lens power information of the user such as left eye power, right eye power or the like. The visual lens power information can be retrieved directly from the user's profile stored at the multi-function device 102. In another example, the visual lens power information can be obtained from the user in real-time. In such cases, a user interface is provided to the user to input his left eye power, right eye power, and/or font/content size that is comfortable for the user. Once obtained, the multi-function device 102 enhances content of the document according to the visual lens power information of the user. For example, if the visual lens power information of the user is +2, then font is increased by 10% such that the user can comfortably read the content of the document. In another example, if the visual lens power information of the user is +1.5, then size of the content is increased by 7% such that the user can comfortably read the content of the document. This way, the content of the document is enhanced according to the visual lens power information of the user and/or choice/preference of the user.

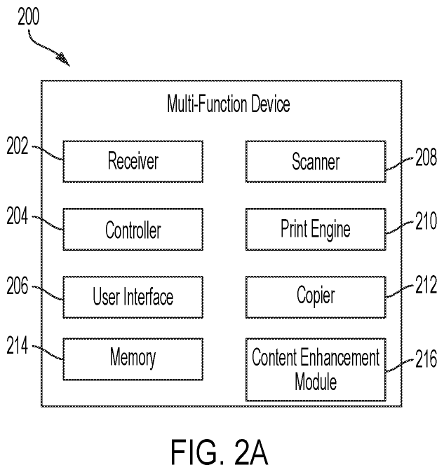

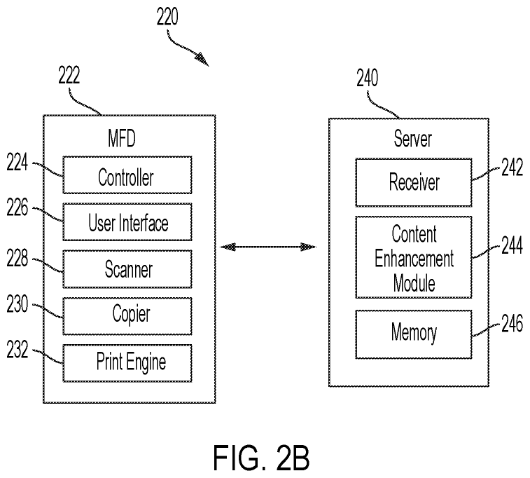

By default, enhancing content of the document includes enhancing content of all pages of the document. As a result, the multi-function device 102 enhances content of all pages of the document. But in other implementations, the multi-function device 102 may enhance content of one or more pages of the document based on the user's preference and/or requirement. In such cases, the user is required to input one or more pages for which he wishes to implement the content enhancement functionality. The user may be required to input page numbers, or one or more keywords for content enhancement. These are few examples, but there can be other parameters for selecting the pages for which the content needs to be enhanced. More structural and implementation details of the disclosure will be discussed below in FIGS. 2A and 2B.

One exemplary implementation of the content enhancement for the user or for the other user is discussed here. In this example, once the document is submitted, the multi-function device 102 provides a user interface including an option to visually enhance content of the document. The user selects the option of enhancing content of the document through the user interface. Upon selecting the option, the multi-function device 102 provides another user interface asking the user if the document is to be enhanced according to his visual lens power information or visual lens power of some other user. In case the user wishes to enhance the document based on his visual lens power information, the multi-function device 102 checks for user's profile that includes visual lens power information of the user. Post checking, the multi-function device 102 enhances the content of the document based on the visual lens power information of the user stored in his profile at the multi-function device 102. In case, the user selects the other option of enhancing the content for some other user, the user is required to input visual lens power information of the other user. The multi-function device 102 enhances content of the document based on the input visual lens power information of the other user.

FIG. 1B shows another exemplary environment 110 in which various embodiments of the disclosure can be practiced. The environment 110 includes a multi-function device 104 that is communicatively coupled to a server 106. The multi-function device 104 and the server 106 collectively forms a system 108. In implementation of FIG. 1A, the multi-function device 102 performs all functionalities of enhancing content of the document such as receiving the document for printing, receiving selection of the visually enhanced content option, retrieving visual lens power information and enhancing content of the document. But in implementation of FIG. 1B, the multi-function device 104 performs some of the functionalities such as receiving the document, receiving the selection of visually enhanced content option, while the server 106 performs the functionality of enhancing the content of the document according to the visual lens power information of the user.

In operation, the multi-function device 104 receives the document from the user for printing. Once the document is received at the multi-function device 104, the user selects an option of enhancing content of the document at the multi-function device 104. The multi-function device 104 obtains the visual lens power information of the user as discussed above. Post this, the multi-function device 104 sends the document along with user's selection of the visually enhanced option and the visual lens power information of the user, to the server 106 for further processing.

The server 106 receives the required details including the document, the selection of visually enhanced content option, the visual lens power information of the user. Post this, the server 106 analyzes the details as received and enhances content of the document according to the visual lens power information of the user. The server 106 then sends an output document having the enhanced content to the multi-function device 104. The multi-function device 104 finally prints the output document having the enhanced content. This way, the content of the document is enhanced that can be easily read, seen, viewed by the user.

### Exemplary Multi-Function Device

FIG. 2A is a block diagram illustrating various components of a multi-function device 200, in accordance with an embodiment of the present disclosure. As illustrated, the multi-function device 200 includes a receiver 202, a controller 204, a user interface 206, a scanner 208, a print engine 210, a copier 212, a memory 214, and a content enhancement module 216. The functionality of the content enhancement module 216 can be incorporated in the controller 204 of the multi-function device 200. The multi-function device 200 may include additional component(s) as required to implement the present disclosure. The multi-function device 200 may perform functions and operations similar to the multi-function device 102 of FIG. 1A. The components 202-216 are connected to each other via a conventional bus or a later developed protocol and these components 202-216 communicate with each other for performing various functions of the present disclosure.

The implementation begins when a user wishes to enhance content of a document according to visual lens power information, such as visual lens power information of the user or visual lens power information of other user, wherein the other user may be his friend, colleague, or in some relation with the user. These are examples but the other user can be any user to whom the user wishes to share or send the document including the enhanced content i.e., the output document. The document can be in any form such as printed on a paper, or the document can be in a digital form. The document can include content in the form of text, image, graphics, or a combination thereof. The document submitted by the user can be for printing, scanning, or copying. In case the document is for printing, the document submitted is in digital form and the output document is in the physical form. In case the document is for scanning or copying, the document submitted is in physical form such as printed on a paper and the output document is in the digital form or physical form, respectively.

Before submitting the document at the multi-function device 200, the user creates his profile for implementing the present disclosure. To this end, a user interface 206 is provided to the user for inputting his details such as username, user email address, password, or the like. In context of the present disclosure, the user inputs his visual lens power information such as left eye power, right eye power, font size, text size or other details relevant for implementing the current disclosure. The visual lens power information can include any information that can be relevant for enhancing content of the document. Based on the visual lens power information of the user, the multi-function device 200 enhances content of the document for any document submitted for printing, scanning, or copying or other imaging functionalities. The user requires to login into the multi-function device 200 for creating his profile. This is just an example, the user can create his profile any time before the content enhancement functionality is implemented at the multi-function device 200.

In operation, the user submits the document for printing at the multi-function device 200. The multi-function device 200 receives the document, specifically, the controller 204 receives the document for printing. Post submitting, the user logs in into the multi-function deice 200 using his username, user ID, employee name, employee ID, passcode, or a combination thereof without limiting the scope. Then, the controller 204 provides the user interface 206 to the user including one or more options such as scan, print, workflow, or the like. In context of the current disclosure, the user interface 206 provides a visually enhanced content option to the user for selection. The user selects the displayed option for enhancing content of the document. The selection of the visually enhanced content option is received by the controller 204. The controller 204 then checks for user's profile as stored in the memory 214 of the multi-function device 200. The controller 204 checks whether the user profile include his visual lens power information. Various examples of the visual lens power information may include left eye power, right eye power, readable content sizes, preferred content sizes, preferred font type, style or the like. The controller 204 identifies and retrieves the visual lens power information of the user from his profile and sends to the content enhancement module 216 for further processing.

The content enhancement module 216 enhances content of the document according to the visual lens power information of the user. For example, if the profile includes the visual lens power information of the user, the content enhancement module 216 enhances content of the document according to the visual lens power information of the user. The content enhancement module 216 here enlarges content including text or other type of content based on the visual lens power information of the user. The content is enlarged such that the enlarged content be easily read by the user and/or is compatible with his eyesight. In one example, the text size can be increased by 2 sizes, 3 sizes, 4 sizes and so on. If the font of the text is arial 10, the content enhancement module 216 may increase the text size by 2 sizes, as a result, the enhanced text is arial 12. This is just one example, the content enhancement module 216 may enhance content using other techniques as known or later developed. While enhancing the content, the content enhancement module 216 may take care of alignment, scaling or other features of the document. The content enhancement module 216 then passes the document including the enhanced content to the controller 204 for further processing. The controller 204 then passes the document including the enhanced content to the print engine 210 for printing. The print engine 210 prints the output document including the enhanced content such that the enhanced content is comfortably read by the user. This way, the output document is generated by the multi-function device 200.

Looping back to the discussion, if the visual lens power information of the user is not found by the controller 204 in the user profile, the controller 204 provides the user interface 206 to the user. The controller 204 requests the user to input visual lens power information through the user interface 206. Upon receiving, the controller 204 proceeds with content enhancement as discussed above. Alternatively, the controller 204 determines visual lens power information of the user basis visual power card test and survey test if the user is not aware of his visual lens power information. The visual power card test can be performed for the digital version and/or the printed version of the document. The controller 204 generates a report of the user which can be downloaded, shared, or displayed to the user. The controller 204 may also allow the user to save the report in the memory 214 of the multi-function device 200. This way, the controller 204 obtains the visual lens power information of the user.

In some implementations, the controller 204 asks the user if he wants to enhance content of the document for himself or for other user. In such cases, the controller 204 provides two options to the user—whether the document is a public document or whether the document is a personal document. If user wants to enhance the document for himself, the controller 204 selects the document is a personal document. In such cases, the controller 204 obtains visual lens power information of the user and performs content enhancement as discussed above. If user wants to enhance the document for other user, the controller 204 selects the document is a public document. In such cases, the controller 204 provides the user interface 206 to the user to input visual lens power information of the other user. The controller 204 automatically enhances content of the document according to the visual lens power information of the other user.

In some implementations, the controller 204 display one or more templates including different content sizes based on different visual lens power. The user can select any of the template for content enhancement. The controller 204 may store the selected template in the user profile for later retrieval and/or use.

In some implementations, the controller 204 calculates the number of pages of the document, based on the content enhancement. After content enhancement, the controller 204 checks if the number of pages increases beyond a threshold limit or size of the document crosses a pre-defined limit, the controller 204 performs optimization. One way of optimization is to enhance content of one or more pages of the document instead of the entire document. In such cases, the controller 204 provides the user interface 206 to input one or more keywords. The controller 204 searches/identifies for one or more pages having the matching keywords and then enhances content of the identified pages having the matching keywords. This way, the multi-function device 200/controller 204 allows the user to do selective content enhancement of the document. This is an example, but the controller 204 may implement keyword-based content enhancement basis user requirement and/or choice.

FIG. 2A is discussed wrt printing scenario, the disclosure can be implemented for scanning or copying scenario. In such cases, the receiver 202 receives the document from the user. The receiver 202 can be a platen or ADH (Automatic Document Handler). The user places the document on the receiver 202. The scanner 208 scans pages of the document placed on the receiver 202. The scanner 208 scans each page of the document and creates intermediate image/raw image. The intermediate images are then sent to the controller 204 for content enhancement.

The controller 204 enhances content of the scanned images and generates a scanned output including the enhanced content. In copy scenarios, the user places the document on a document feeder. The copier 212 creates a copy of the document and passes the copy of the document to the controller 204. The controller 204 enhances content and generates an output document including the enhanced content.

The memory 214 stores user profile including user details, visual lens power information, templates, user preference, document for printing, printing attributes, scan attributes, copy attributes, or other details relevant for implementing the current disclosure. The controller 204 or other components may retrieve the required details from the memory 214. The user interface 206 can be used for displaying information to the user such as various options including visually enhanced content option, or notification to the user. The user interface 206 can be used for inputting various information such as visual lens power information of the user or the like.

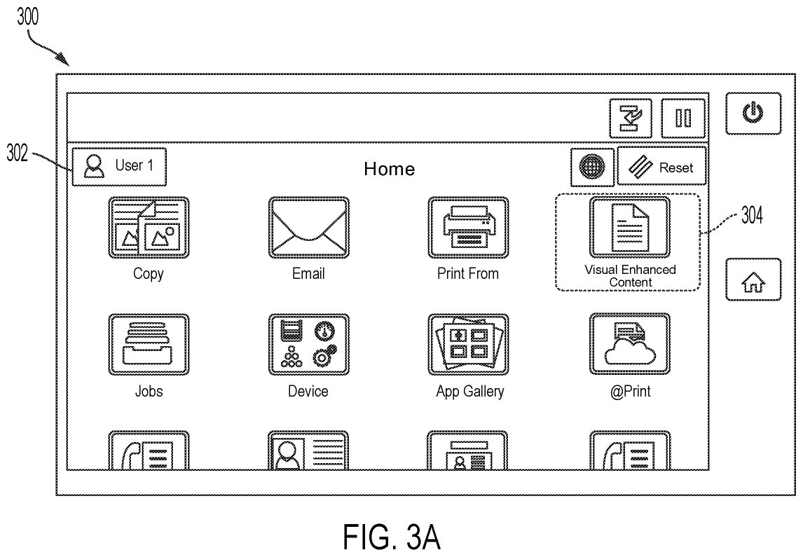

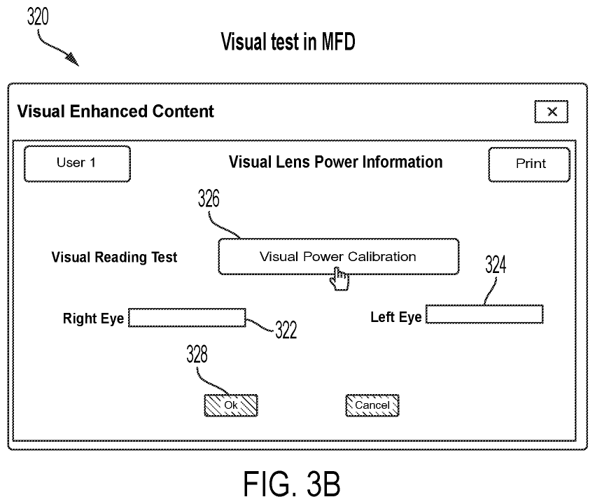

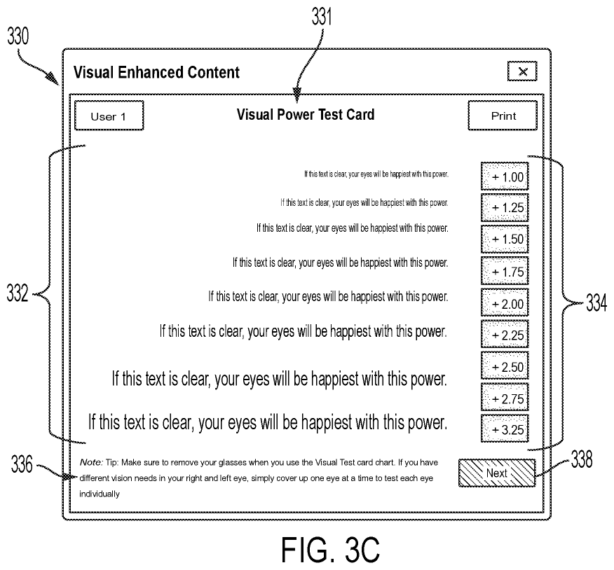

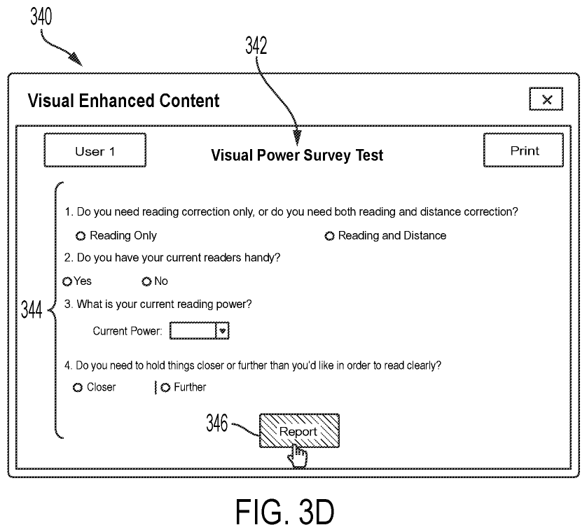

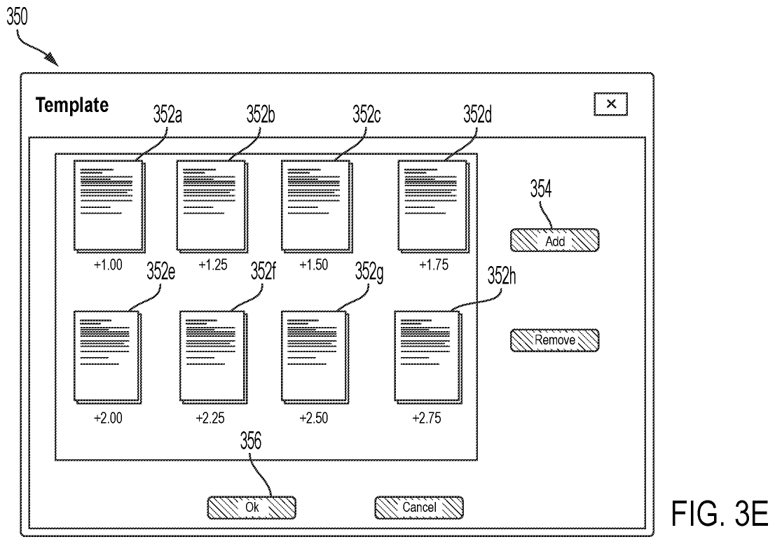

Few exemplary snapshots are discussed for better understanding of the disclosure. An exemplary user interface such as 300 displayed to the user (such as ‘User 1’ marked as 302) after logging in, is shown in FIG. 3A. As clearly shown, the user interface 300 includes an option of visually enhancing the content (marked as 304). The option is named as ‘Visual Enhanced Content’ 304 in the user interface 300, but the option 304 can be assigned any names such as enhance content, content enhancement, and so on. The user 302 selects the option 304 to input and/or store user's visual lens power information. The input information can then be stored in user's profile for later retrieval and/or use. Upon selecting the option 304, another user interface 320 is displayed to the user as shown in FIG. 3B. The user 302 inputs his visual lens power information via the user interface 320. As shown, the user 302 inputs power of his right eye (marked as 322) and power of his left eye (marked as 324). The user interface 320 further includes an option of visual power calibration (marked as 326). The user 302 selects the visual power calibration option 326 in case he is not aware of his visual lens power, or his power is changed, or he wishes to calibrate and then input his visual lens power information. Once the details are submitted, the user 302, can click on option ‘Ok’ (marked as 328) to submit his selection. The user can skip the visual power calibration option 326 if he submits the left and eight eye power information to be used for content enhancement. If the user selects the option 326 to calibrate his visual power, another user interface 330 including a visual lens power test card 331 is displayed to the user, as shown in FIG. 3C. The visual lens power test card 331 includes text of different sizes (collectively marked as 332) and their corresponding visual lens power (collectively marked as 334). The user can see, read, view the text of different sizes 332 and see which text size is comfortable for the user. The card 331 includes a note or instructions, marked as 336 for the user. For example, the instructions 336 may be for the user to remove the spectacles or other visual aids so that he can select the font size that he can read comfortably without the need of visual aid. Another exemplary instruction may be to perform the test twice (i.e., one for each eye) in case the visual lens power for right and left eye is different. The user can select any text size basis his comfort or compatible visual lens power information and submits his selection and clicks on ‘Next’ button 338. Subsequently, another user interface 340 including a survey test 342 is displayed to the user as shown in FIG. 3D. The survey test 342 is a part of the visual lens power test.

As shown, the survey test 342 includes one or more multiple-choice questions (collectively marked as 344) that are to be filled by the user. The questions are related to reading power, short-sightedness, long-sightedness, and so on. Once the user answers all the questions, he submits his selection. The user can also generate/download or print a report (marked as 346). The report 346 includes the visual lens power information of the user that is determined after performing the visual lens power test and survey test, as shown in FIG. 3C and FIG. 3D respectively. This way, visual lens power of the user is determined and saved in user's profile for later use and/or retrieval.

In some implementations, the user interface 206 displays one or more templates that can be selected by the user for content enhancement. Each template includes text of different font sizes to cover a wide range of visual lens powers. One such exemplary user interface 350 displaying multiple templates for user's selection is shown in FIG. 3E. As shown, the user interface 350 includes a template 352a having the text/font size compatible to visual power +1. The user opens the template and checks if the font size is comfortable to read without visual aid. Similarly other templates provided are—template 352b for visual power +1.25, template 352c for visual power +1.50, template 352d for visual power +1.75, template 352e for visual power +2.00, template 352f for visual power +2.25, template 352g for visual power +2.50, and template 352h for visual power +2.75. Here, the user can check any of the given templates 352 and can add one or more templates having comfortable/compatible text size to his profile using the option “Add”, marked as 354. Once done, the user submits his selection using “Ok” option, marked as 356. The templates selected and stored in the user's profile can be retrieved and/or used for enhancing content of the document submitted by the user for printing, scanning or copying.

This way, the visual lens power information of the user is obtained either by determining using visual tests or as input by the user as discussed above. Specifically, the controller 204 receives the visual lens power information. The controller 204 then stores the visual lens power information in the memory 214. When the user selects the option of ‘visual enhanced content’, the controller 204 retrieves the stored information from the memory 214 and enhances the content of document according to the user's visual lens power information.

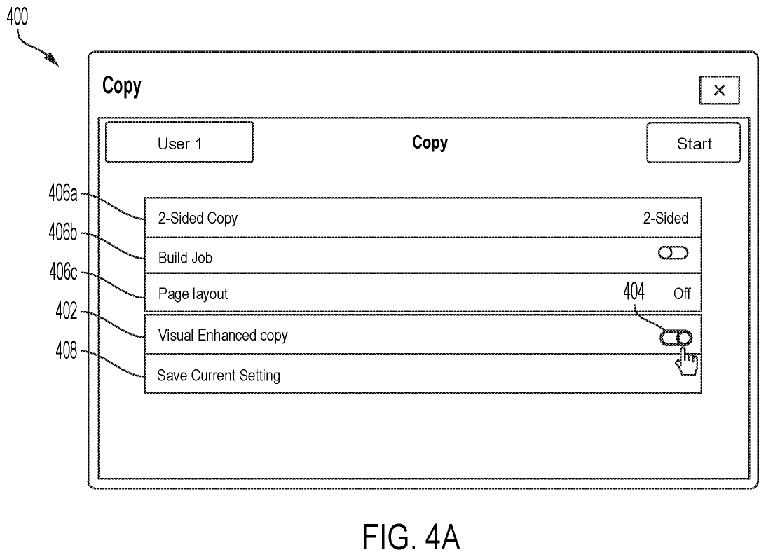

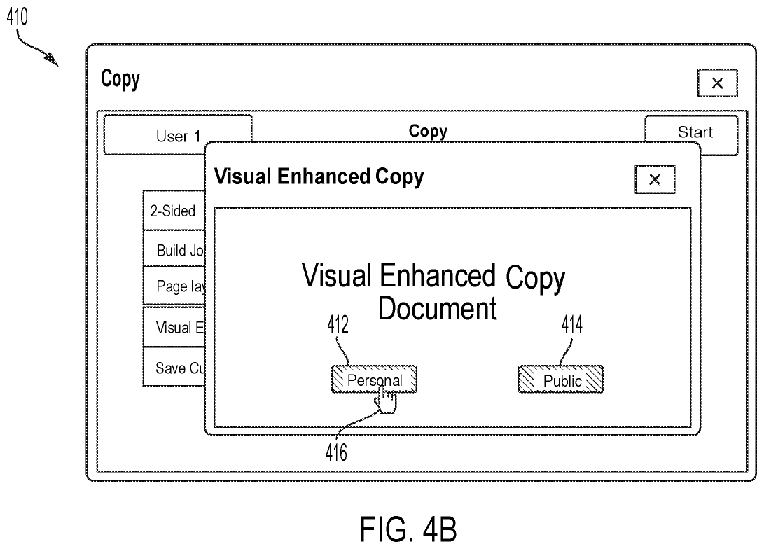

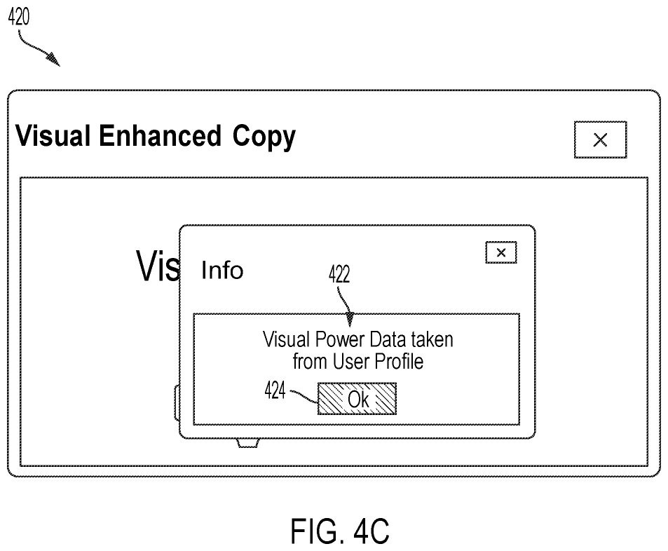

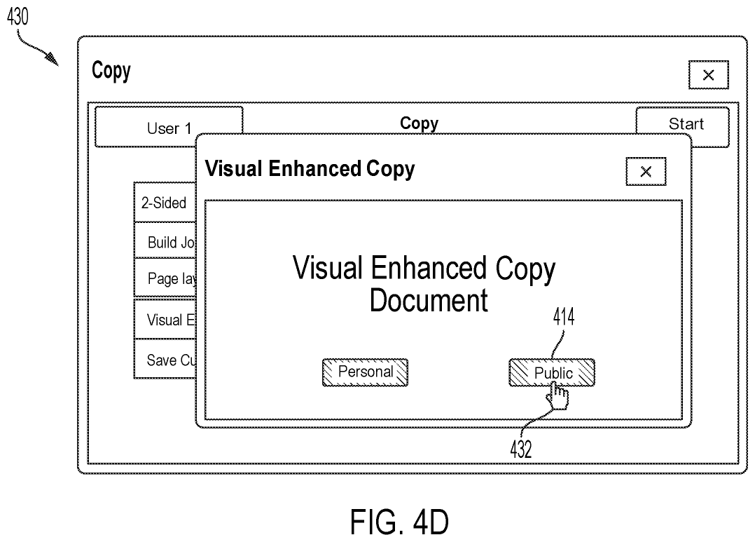

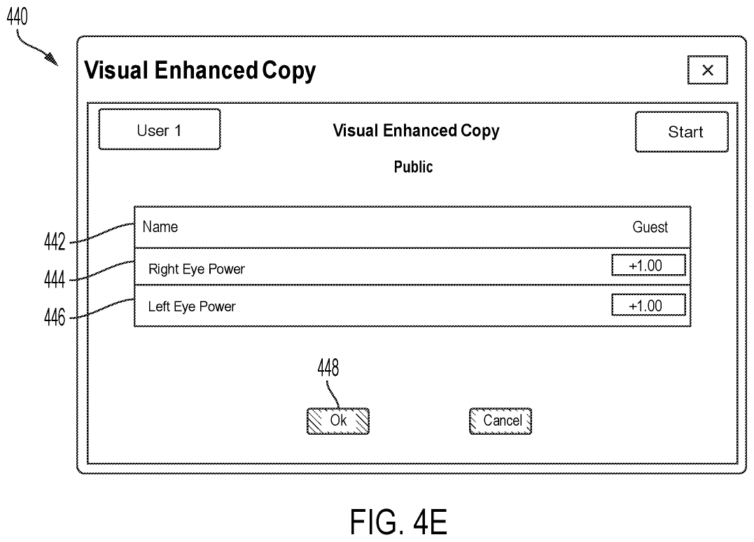

One exemplary user interface 400 for a copy workflow is shown in FIG. 4A, the interface 400 includes an option 402 for enhancing content of a document submitted for copying. As shown, the option 402 is named as ‘visual enhanced copy’ but the option 402 can have other names without limiting the scope. The user can enable the option 402 by turning the button in CON′ position (marked as 404). The user interface 400 further includes other copy parameters such as 2-sided copy 406a, build job 406b, page layout 406c (collectively 406). These are exemplary parameters 406 and the user interface 400 can include any number and type of copy parameters. The user can save the selected parameters by clicking on the option save current settings option, marked as 408.

Upon enabling the content enhancement option 402 via the user interface 400, another user interface is displayed to the user asking if the document is for personal use or public use. One such exemplary user interface 410 displaying the two options is shown in FIG. 4B. The options are shown as ‘personal’ 412 and ‘public’ 414. The personal option 412 indicates the user is creating a copy of the document for himself, while the public option 414 indicates the user is creating a copy for some other user. If the user selects the option 412, the visual lens power information stored in the user's profile is used to enhance the content of the document. If the user selects the option public 414, the user is required to input visual lens power information of the other user. When the user selects (the selection shown via 416) the ‘personal’ 412 option, visual lens power information is taken from user's profile as the user has stored his power information in his profile (as discussed in FIGS. 3A-3E). Upon selecting the personal option 412, a user interface 420 is displayed to the user (as shown in FIG. 4C) confirming that the information is fetched from his profile (marked as 422). The user confirms fetching of visual lens power information by clicking on ‘ok’ option, marked as 424. If the user chooses the public option 414 selection shown via 432 in a user interface 430 of FIG. 4D, another user interface 440 as shown in FIG. 4E is displayed to the user. As shown, the user is required to input name of the other user (under the name field, marked as 442) to whom he wishes to send the copied document. Here, the user enters ‘Guest’ under the name field 442. Subsequently, the user inputs right eye power (marked as 444) and left eye power (marked as 446) of the guest user. Here, the power of guest user is +1 for both the eyes. Once the user fills the required details, he submits the selection via Ok button, marked as 448. While not shown, the user may save the details of the guest user in the memory 214 of the multi-function device 200 for later use and/or retrieval. This way, the visual lens power information of the other user or the guest user is received by the controller 204 for content enhancement. For easy discussion, it is considered that the user copies the document for himself, and his visual power information is considered for further processing.

Once the visual lens power information is received by the controller 204, the controller 204 enhances the content of the document. In particular, the size of the text included in the document is increased or enlarged to match the visual lens power of the user. In some implementation, enhancing the document includes enlarging the graphics, images, or other suitable types of content. As enhancing or enlarging the content of the document may increase the number of pages of the document, thus, the controller 204 re-calculates the number of pages based on the content enhancement. The controller 204 then displays the increased number of pages to the user via the user interface 206 for his confirmation. In some cases where the number of pages is increased beyond a desired limit, the user interface 206 provides an additional option of enhancing the document based on one or more keywords. Such option allows the user to input one or more keywords via the user interface 206 such that the controller 204 searches for the input keywords in the document. The controller 204 then identifies one or more pages in the document that includes the matching keywords. Subsequently, the controller 204 enhances the pages having the matching keywords. For example, if the user inputs a keyword ‘blockchain’, pages of the document including the matching keyword are enhanced. The controller 204 further displays the updated number of pages to the user via the user interface 206 for his confirmation. The user can add/delete one or more keywords to optimize the overall number of pages having enhanced content. This selective content enhancement allows the user to maintain overall size of the document within a pre-defined/required limit. For example, if the user is copying a large document and wishes to keep the output document size under 30 MB, he can enhance content of pages using keyword-based approach so that the overall number of pages remain within the desired limit. This way, the multi-function device 200 allows the user to create an output document having the enhanced content within required file size.

Upon confirmation from the user, the controller 204 generates an output document having the enhanced content. This way, the user can read/view the content of the copied document comfortably.

Here, FIG. 2A is discussed wrt to a scenario, where the multi-function device 200 enhances content of the document submitted for copying, according to the visual lens power information of the user. But it is understood that the disclosure can be implemented for scenarios where the document is submitted for scanning or printing. In scanning cases, the scanner 208 scans pages of the document and passes the scanned pages to the controller 204 for further processing. The controller 204 then retrieves the profile of the user and identifies the visual power information of the user. Based on the visual power information, the controller 204 enhances the content of the scanned pages and generates a scanned output/document having the enhanced/enlarged content. In printing cases, the controller 204 receives the document for printing, retrieves the profile of the user and identifies the visual power information of the user. Based on the visual power information, the controller 204 enhances the content of the document and passes the document with enhanced document to the print engine 210 for printing. The print engine 210 outputs the printed document having the enhanced content.

FIG. 2A is discussed for scenarios when the visual lens power information is stored at the multi-function device 200 or known to the user but there can be scenarios when the user is not aware of visual lens power information. In such cases, the user can undergo the visual lens power test and survey test to determine power information for his right and left eye. The power test and survey test can be performed similar to the tests discussed in FIGS. 3B-3D. Based on the determined visual lens power information, the content can be enhanced for the user. In some implementations, the user can select one or more templates (as shown in FIG. 3E) such that the selected template includes text size that is comfortable for the user.

Further, FIG. 2A is discussed for scenarios where the user enhances content of the document according to his visual power information. But the disclosure can be implemented for scenarios where the user enhances content of the document for another user or a guest user. In such cases, the user inputs visual power information of the other user basis which content of the document is enhanced.

FIG. 2B is a system 220 including a multi-function device 222 and a server 240, in accordance with an embodiment of the present disclosure. The multi-function device 222 is communicatively coupled to the server 240 via a communication network to perform various tasks. The communication network may be a wireless network, a wired network, or a combination thereof. The communication network may be implemented as one of the different types of networks such as intranet, Local Area Network (LAN), Wide Area Network (WAN), the Internet, and the like. The communication network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network may include a variety of network devices, including routers, bridges, servers, computing devices, storage devices, and the like.

As shown, the multi-function device 222 includes a controller 224, a user interface 226, a scanner 228, a copier 230, a print engine 232 and a memory (not shown), while the server 240 includes a receiver 242, a content enhancement module 244, and a memory 246. The multi-function device 222 and the server 240 may perform functions and operations similar to the multi-function device 104 and the server 106 of FIG. 1B, respectively. The system 220 may include additional component(s) as required to implement the present disclosure. In FIG. 2A the multi-function device 200 performs all functionalities related to content enhancement, whereas in FIG. 2B, the multi-function device 222 and the server 240 together implements the present disclosure. For example, some functionalities are implemented at the multi-function device 222, while some functionalities are implemented at the server 240.

In operation, a user submits a document for printing at the multi-function device 222. The user wishes to enhance content of the submitted document. Once the document is submitted, the multi-function device 222, specifically, the controller 224 receives the document. The controller 224 then provides a user interface 226 to the user including an option to enhance content of the document as discussed above in detail. The user selects the option along with one or more other print related parameters such as print color, 2-sided print, and so on. The controller 224 further checks a profile of the user for his visual lens power information and retrieves the visual lens power information of the user.

The multi-function device 222 sends the document, the selected option and the visual lens power information to the server 240 for processing. The receiver 242 receives the document along with the selected option and the visual lens power information. The received details are stored in the memory 246 for later retrieval and/or use. The receiver 242 passes the document and the visual lens power information to the content enhancement module 244 for further processing. The content enhancement module 244 analyzes the document and the user selected options based on which content of the document is to be enhanced. The content enhancement module 244 enlarges text of the document according to the visual lens power information of the user.

Once the content of document is enhanced, the document is sent back to the multi-function device 222 and the enhanced content document is displayed via the user interface 226 for user's confirmation. If user confirms that the enhanced document along with increased number of pages are as desired, the controller 224 triggers the print engine 232 and an output document having enhanced content is printed. In some implementations, the user may submit his inputs such as one or more keywords based on which pages including the input keywords are enhanced. In such cases, the revised inputs are sent to the server 240. The content enhancement module 244 searches pages of the document having the input keywords. The content enhancement module 244 identifies one or more pages including the keywords and enlarges the content of the identified pages. The enhanced document is then sent back to the multi-function device 222 and the user checks the number of pages in a preview mode for his confirmation. Once the user confirms and submits his confirmation, the controller 224 triggers the print engine 232 and the printed document having the enhanced content is output.

While the above example is discussed for printing, the system 220 can be implemented for scanning or copying scenarios. In scanning and copying scenarios, the controller 224 of multi-function device 222 triggers the scanner 228 and copier 230 to generate the scanned document having the enhanced content and copy of the document including the enhanced content, respectively.

### Exemplary Snapshots

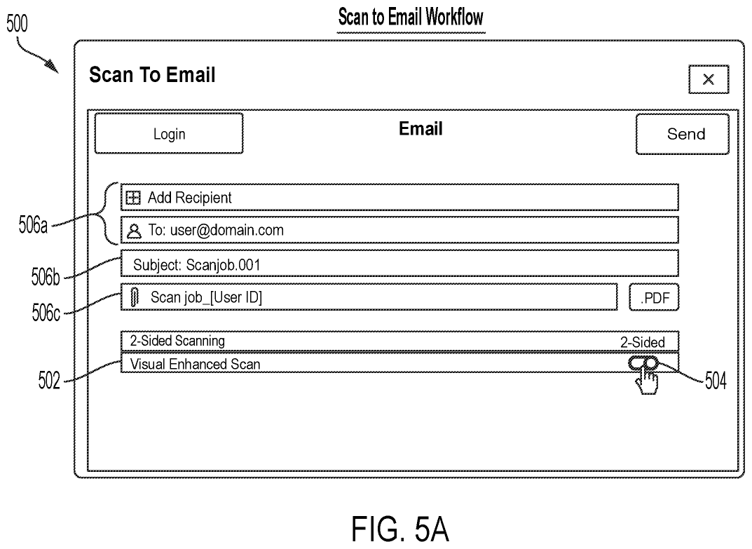

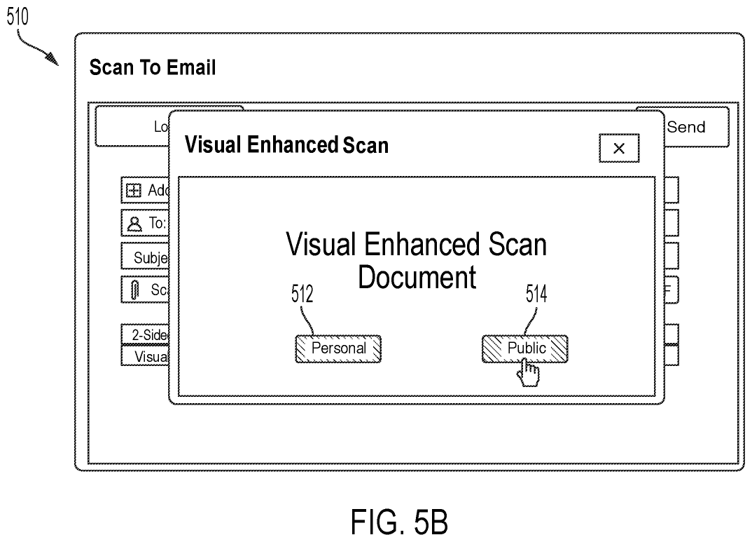

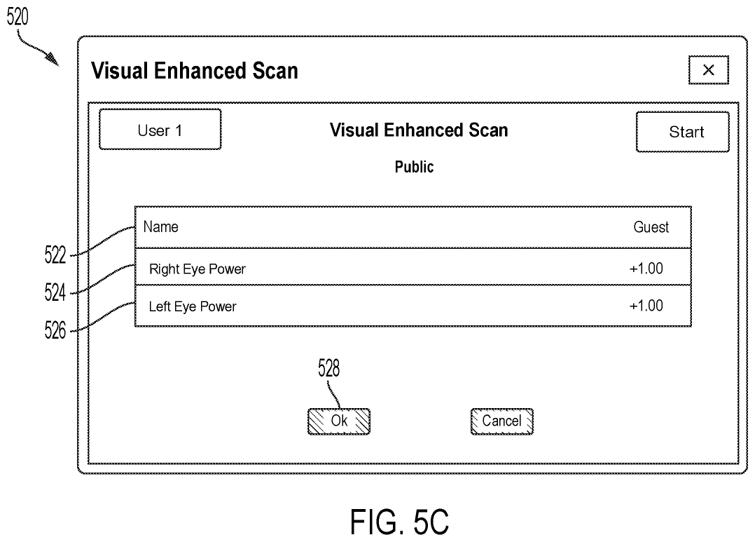

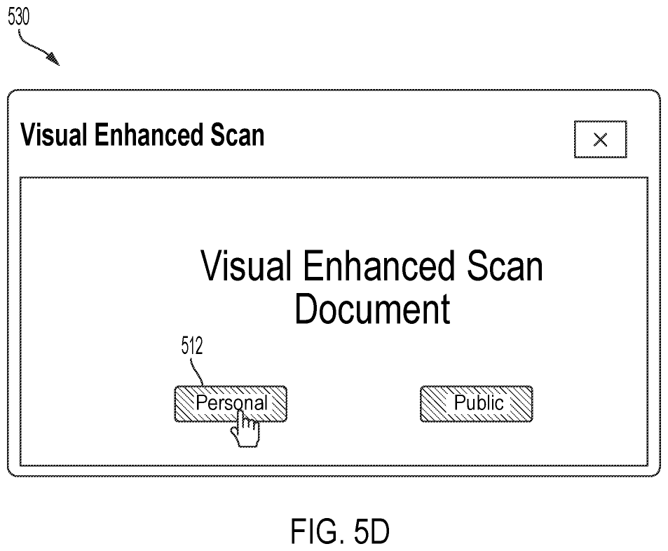

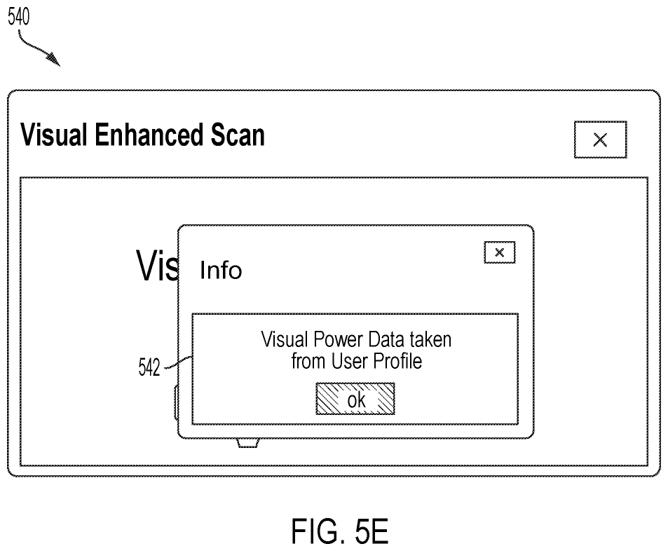

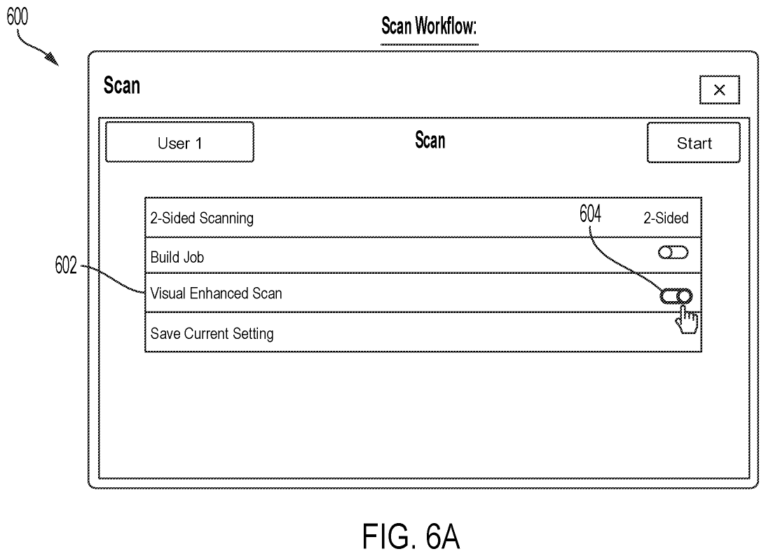

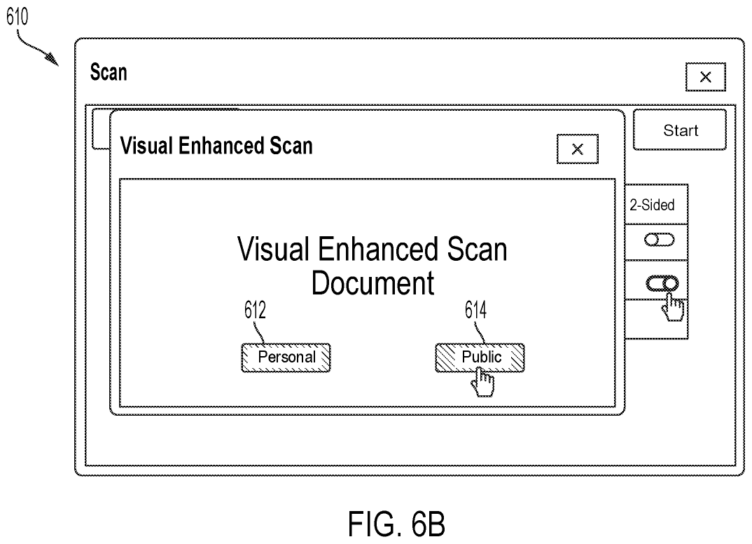

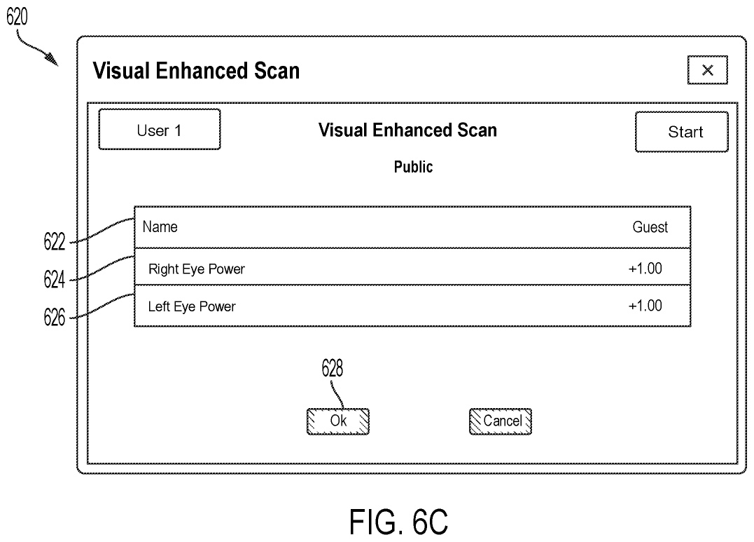

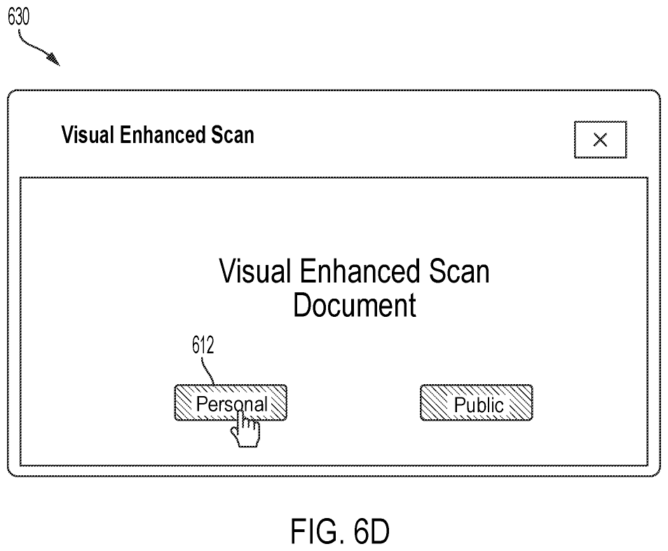

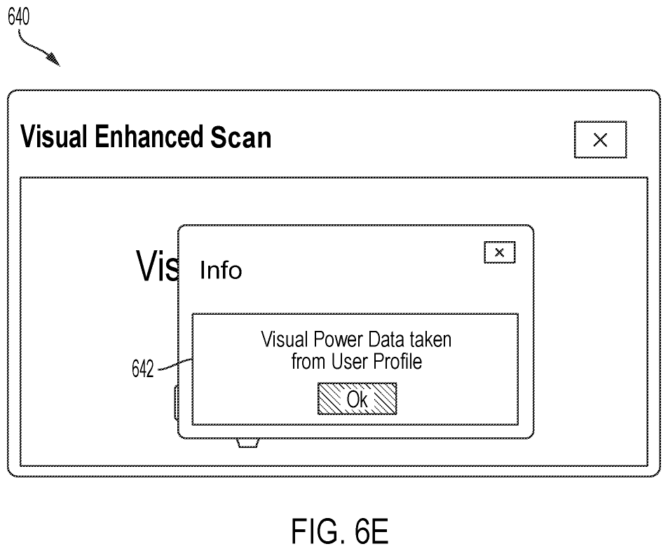

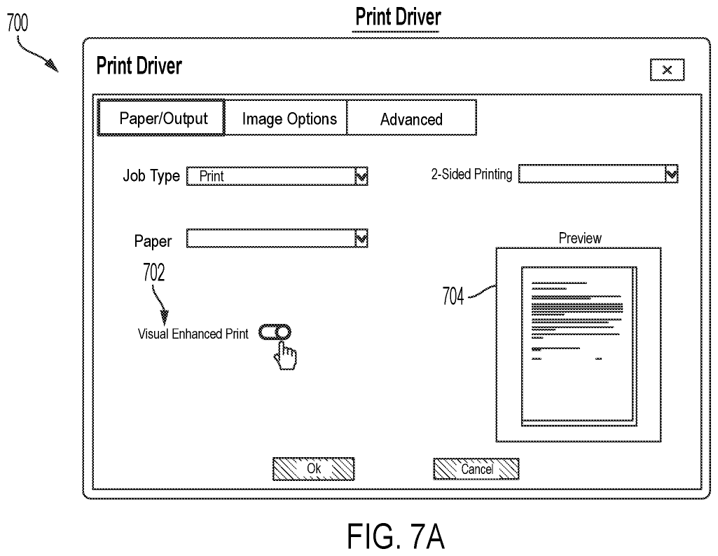

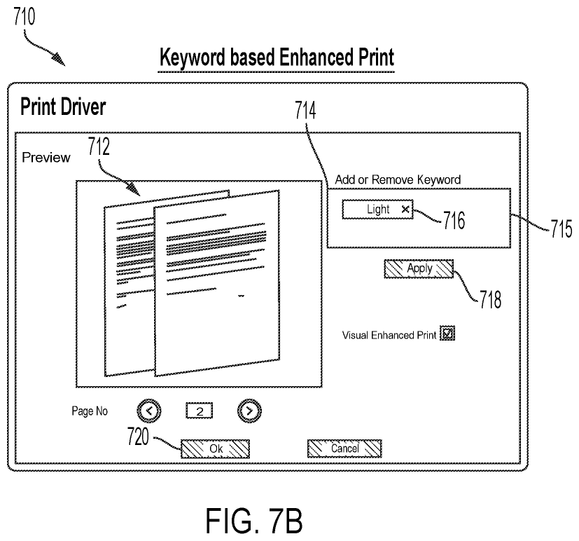

The multi-function device 200 and the system 220 discussed above in FIGS. 2A-2B can be used to enhance content of documents that are submitted for various operations including scanning, copying and printing. FIGS. 5A-5E, 6A-6E, 7A-7E show various workflows for implementing the current disclosure. For example, FIGS. 5A-5E show exemplary snapshots implementing content enhancement for ‘scan to email’ workflow, FIGS. 6A-6E show snapshots implementing content enhancement for ‘scan’ workflow, and FIGS. 7A-7B show snapshots implementing content enhancement for printing workflow.

When a user accesses a scan to email workflow on the multi-function device such as 102, a user interface 500 is shown to the user. The user interface 500 includes one or more scan parameters for scanning the document. In disclosure context, the user interface 500 includes an option visually enhanced scan marked as 502. The user selects the option 502 by sliding a button to ON position (marked as 504). The user also selects one or more scan parameters such as—the user adds a recipient user@domain.com (marked as 506a), inputs a subject ‘Scanjob.001’ (marked as 506b), and attaches a file ‘Scan job_[User ID]’ (marked as 506c). Once done, another user interface 510 as shown in FIG. 5B is displayed to the user. The user interface 510 asks the user to select one of the following options—personal 512 or public 514, where the personal option 512 indicates that the user is scanning the document for his personal use and the public option 514 indicates that the scanned document is for another user. If the user selects public option 514, another user interface 520 as shown in FIG. 5C is displayed to the user asking him to input one or more details related to the other user. As shown in FIG. 5C, the user interface 520 provides options to include name of the other user (marked as 522), his right eye power (marked as 524), and his left eye power (marked as 526). Upon inputting the details, the user submits the information by clicking on ‘Ok’ (marked as 528). If the user selects the personal option 512, the selection is shown in the user interface 530 of FIG. 5D, the user profile is checked for his visual lens power information. Based on the check, the user's visual lens power information is taken from his profile as displayed, marked as 542, in the user interface 540 of FIG. 5E.

When a user accesses a scan workflow on the multi-function device, a user interface 600 is shown to the user. The user interface 600 includes one or more scan parameters and in context of the current disclosure, the user interface 602 includes visual enhanced scan option, marked as 602 in FIG. 6A. The option 602 is displayed to the user for selection. As shown, the user selects the option 602 by sliding a button to ON position (marked as 604). The user also selects one or more scan parameters as discussed above. Post selection, another user interface 610 as shown in FIG. 6B is displayed to the user. The user interface 610 asks the user to select one of the following options—personal 612 or public 614. The user selects public 614 option when he is scanning the document for another user. If the user selects the option 614, another user interface 620 as shown in FIG. 6C is displayed to the user for inputting one or more details related to the other user. As shown in FIG. 6C, the user interface 620 provides options to include name of the other user (marked as 622), his right eye power (marked as 624), and his left eye power (marked as 626). Upon submitting the details, the user submits the information by clicking on ‘Ok’ (marked as 628). If the user selects the personal option 612, where the selection is shown in the user interface 630 of FIG. 6D, the user profile is checked for his visual lens power information. Based on the check, the user's visual power information is taken from his profile marked as 642 in user interface 640 of FIG. 6E.

When a user accesses a print workflow on the multi-function device, a user interface 700 is shown to the user. The user interface 700 includes one or more print parameters and in context of the current disclosure, the user interface 700 includes option visual enhanced print 702 to create a visually enhanced printed document. The user selects one or more print parameters such as 2-sided print, paper to be used for printing, etc. along with the option 702. Once the user selects the option 702 and the parameters, he can submit his selection. In some cases, the user may wish to enhance one or more pages of the document. In such scenarios, the user clicks on a print preview option (marked as 704). Upon selecting the preview option, another user interface 710 is displayed to the user. The user interface 710 shows pages of the document in preview mode (marked as 712) and further provides an option (marked as 714) to input one or more keywords. Upon selecting the option 714, user can input one or more keywords in a text box (marked as 715). As shown, here the user inputs a keyword ‘Light’ 716. Upon clicking on ‘Apply’ 718, the multi-function device searches for the keyword 716 in the document. Based on searching, pages including the keyword 716 are identified and shown to the user in preview mode 712. The user can add/delete one or more keywords to select the number of pages to be enhanced. Once the user finalizes the keywords, the user can click on the option 720. The multi-function device prints the document, where content of the pages having the finalized keywords is enhanced. The printed document includes enlarged content of the pages having the input keywords 716. This way, user can optimize the content enhancement.

### Exemplary Implementation

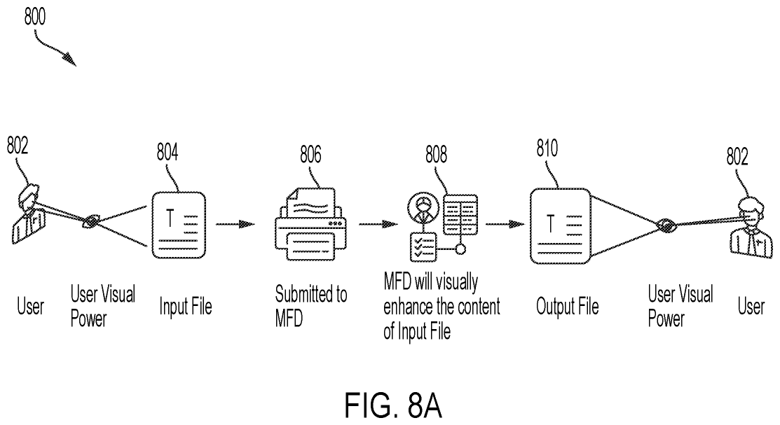

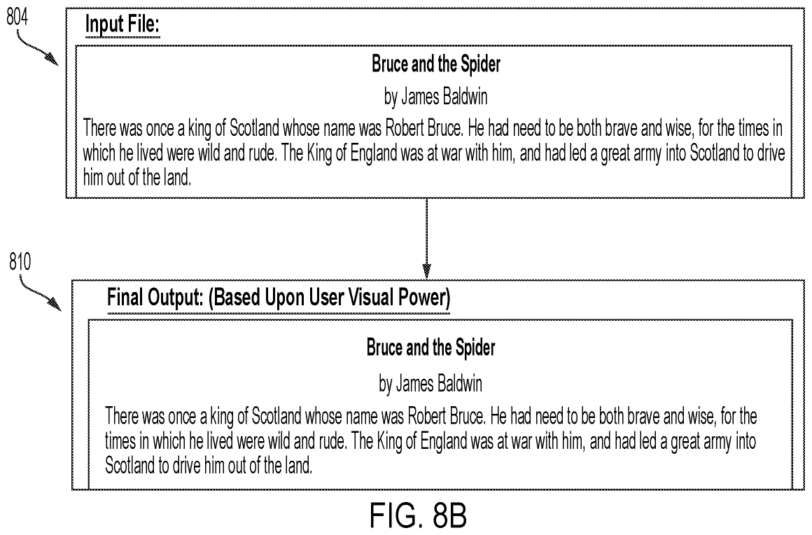

FIGS. 8A-8B show exemplary implementation 800 of the present disclosure. The implementation 800 includes a user 802 who wishes to scan an input document/file 804 at a multi-function device 806. While scanning the document, the user 802 realizes that the content of the document 804 is too small to read comfortably. So, he wants to enhance or enlarge the content of the document. Then, the user enables an option to visually enhance content of the document at the multi-function device 806. Upon enabling the option, the user inputs his right and left eye power and stores the same in the memory of the multi-function device 806. Based on the input power information, the content of the document is automatically enhanced. Also, the power information is stored in the memory of the multi-function device 806 for enhancing content of future documents.

Based on the received power information, the multi-function device 806 enlarges the content of the document (marked as 808) and generates an output scanned document 810. The user 802 can read the content of the scanned document comfortably without visual aid. FIG. 8B shows snapshot of the input document 804 that is submitted at the multi-function device 806 and the enlarged document 810 that is generated after enhancing the content of the document 804.

### Exemplary Method Flowcharts

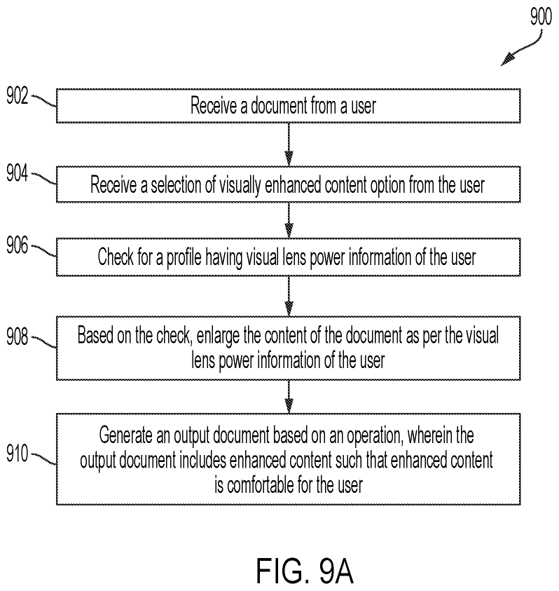

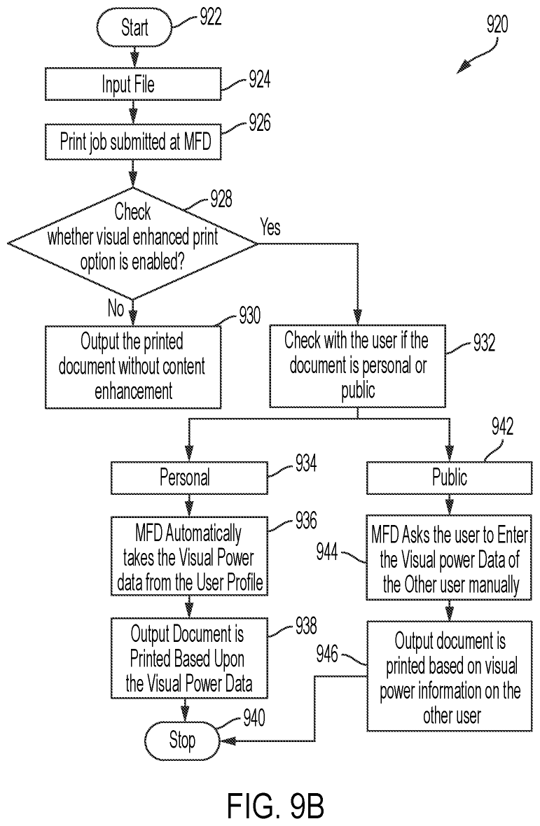

FIG. 9A is an exemplary method flowchart 900 for enhancing content of a document. The method 900 is implemented at a multi-function device, such as the multi-function device 102 of FIG. 1A, or the multi-function device 200 of FIG. 2A. However, the method 900 can be implemented using the system 108 of FIG. 1B, or the system 220 of FIG. 2B.

The method 900 allows a user to enhance content of a document based on visual lens power information. The visual lens power information can be of the user or can be of other user. If the user wishes to enhance content of the document for himself, then the method 900 uses visual power information of the user. If user wishes to enhance content of the document for some other user, then the method 900 uses visual power information of the other user. The method 900 is discussed for a scenario where the user enhances content of the document according to his visual lens power. But the method 900 can be implemented for scenarios where the user wishes to enhance the content of the document according to visual lens power of other users—his friends, family, colleagues, or others. Further, the method 900 can be implemented for the document submitted for scanning, copying, or printing at the multi-function device such as 102 and generates an output document having enhanced content which is comfortable for the user and/or compatible with his visual lens power. For example, the user can comfortably read the enhanced content of the document without requiring any visual aid such as spectacles or power lenses.

The method 900 begins when the user submits the document at the multi-function device for one of the following operations—printing, scanning, or copying. The user can submit the document either directly at the multi-function device or via a computing device. If the user submits the document for printing, the document can be selected and submitted via a computing device of the user. Alternatively, the document can be directly selected and submitted at the multi-function device using one or more ways as discussed above. If the user submits the document for scanning or copying, the document needs to be submitted at the multi-function device directly. For example, for scanning, the user can submit the document at a platen or Automatic Document Feeder (ADH) of the multi-function device. In another example, for copying, the user can submit the document at a feeder of the multi-function device. In copying or scanning scenarios, the document is in printed/physical form, but in case of printing, the document is in digital form.

The method 900 begins when the user wishes to enhance content of a document submitted for printing, for example. The document can be one page document or a multi-page document and can have content including text, image, graphics, or a combination thereof.

At 902, the document submitted by the user is received for a pre-defined operation such as printing. Then a user interface is displayed to the user with one or more options as discussed above. In context of the current disclosure, the user interface includes an option to visually enhance content of the document—visually enhanced content. The user selects the visually enhanced content option displayed to the user. The visually enhanced content option is displayed to the user for selection via the user interface. The selection of the visually enhanced content option allows the user to enlarge content of/in the document such as text, image, graphics or a combination thereof. At 904, the selection of the visually enhanced content option is received from the user. The selection of the option by the user enables or activates the content enhancement functionality at the multi-function device such as 102. In some examples, the content enhancement functionality can be enabled by default by an admin user or by an organization. At 906, a user profile is checked for visual lens power information of the user. Based on the check, the content of the content is enlarged according to the visual lens power information of the user, at 908. Finally, at 910, an output document is generated based on the pre-defined operation where the output document includes enhanced content such that the enhanced content is comfortably read by the user. If the pre-defined operation is printing, then the output document is a printed document including the enhanced content. If the pre-defined operation is scanning, then the output document is a scanned document including the enhanced content. If the pre-defined operation is copying, then the output document is a copied document including the enhanced content.

In some implementations, upon selection of the visually enhanced content option, a user interface including options of ‘public document’ and ‘personal document’ is displayed to the user for his selection. The option ‘public document’ indicates that the document submitted by the user is not for his personal use and the document for some other user. The option ‘personal document’ indicates that the user is printing the document for his personal use.

The user can select one of the abovesaid two options. If the user selects the option ‘public document’, then a user interface is displayed to the user to provide visual lens power information of the other user. The user requires to input left eye power information and/or right eye power information of the user who is going to receive the scanned document. For example, if the user is printing the document for a user having eyesight +1.5 for both the eyes, he is required to put the value +1.5 against the left eye and right eye power information in the user interface. If the user selects the personal option, then the visual lens power information of the user is directly retrieved from the user profile as stored. If the visual lens power information is not stored in the user profile, then the user can input his visual lens power information for further processing. Alternatively, the method 900 can determine the visual lens power information of the user basis visual card test and survey test as discussed above in detail. In such cases, the determined visual lens power information is considered for content enhancement. This way, the visual lens power information is obtained.

Once obtained, the content of the document is enhanced. The content enhancement includes increasing size of the textual content. The content enhancement may include increasing size of the image, graphics, or a combination thereof. The content enhancement may include changing font type, font style or a combination of these. The content is enhanced such that the user can comfortably read the content of the output document with/without any visual aid or stressing his eyes. The content is enhanced for better readability and visibility for the user.

In some implementations, the visual lens power information used to enlarge the content of the document can be saved as a template for future use. In such cases, the user can select the saved template to enhance content of any future documents submitted for scanning, copying or printing operations.

In some implementations, once the content is enhanced as per user's visual lens power information, number of pages based on content enhancement are calculated. For example, if the text enhancement doubles the text size of the content, the number of pages of the document may also get doubled. For example, if the document submitted for scanning includes 10 pages, after content enhancement, the number of pages may increase to 20 pages. The increased number of pages are shown to the user via the user interface for his confirmation. Once user submits his confirmation, the final scanned document is output. The scanned document can then be sent to one or more desired destinations such as email addresses, USB drive, cloud locations, and so on.

If the user wishes to reduce the number of pages that are increased due to content enhancement, the method 900 may implement a keyword-based approach. The keyword-based approach may allow the user to enhance content of specific pages of the document where the user provided keywords are present. In this keyword-based approach, a user interface is provided to the user to input one or more keywords for content enhancement. Once the one or more keywords are inputted by the user, then one or more pages of the document including the input one or more keywords are identified. For example, if the user is scanning a 10-page document and wishes to enhance content of pages including a keyword ‘crypto-currency’, the user inputs the keyword ‘crypto-currency’ via the provided user interface. Once the user submits his inputs, the pages including the input keyword are identified. So here, the pages having the keyword ‘crypto-currency’ is enhanced according to user's visual lens power information and remaining pages are not enhanced.

Subsequently, the document including enhanced content are displayed to the user for his confirmation. At this stage, the user can further optimize the number of pages by editing the input one or more keywords or can confirm the document including enhanced content. Basis the user confirmation, the scanned output including selective content enhancement is displayed and sent to the user. This way, the user can optimize or selectively enhance content of the document to optimize the number of pages or size of the output/scanned document. This option can be useful when the user is required to email the scanned document and he is allowed to email the document if it is within a desired size limit. The selective content enhancement of pages based on keywords optimizes the final document size and the user can send the scanned document to one or more desired destinations.

The method 900 can be implemented for other scenarios including printing, copying, or other imaging operations.

FIG. 9B is an exemplary method flowchart 920 for enhancing content of a document according to visual lens power of a user and printing the document including the enhanced content. The method 920 starts at 922 when the user selects an input file (marked as 924) to be printed. The user then submits the input file at the MFD for printing, at 926. Upon submission, it is checked whether the visually enhanced print option is enabled at 928. If not enabled, the document is printed without any content enhancement at 930. Otherwise, the method 920 proceeds further at 932. It is then checked if the document submitted is personal or public at 932. Basis the input from the user, the method 920 proceeds further. If the user selects that the document is for personal use, at 934, then profile of the user is checked for visual power information of the user. The visual lens power information includes left lens power and right lens power of the user. In particular, the user profile including his left and right eye power information is checked. Once checked, the visual lens power information is automatically taken from the user profile at 936. At 938, the document is printed according to the visual lens power information of the user and the method stops at 940. Finally, the user can read the content of printed document comfortably.

If the user selects that the document is public document, as shown at 942, the user is required to manually input visual lens power information of other user at 944. Then output document is printed according to visual lens power information of the other user at 946. The user then shares the output document to the other user. Finally, the other user can read the enhanced content of the document comfortably.

The order in which the methods 900 and 920 are described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be implemented in the above-described system and/or the apparatus and/or any electronic device (not shown).

The present disclosure provides methods and systems for enhancing content of a document according to visual lens power information. The methods and systems enhance content of the document such that any user can comfortably read, see, or view the document, for example, without using any visual aid, without stressing his eyes, or from a specific distance and so on. The methods and systems require minimal effort and time from the user. The methods and systems additionally allow the user to do selectively content enhancement. For example, the methods and systems allow the user to enhance content of specific pages based on keywords, page numbers, or other selected pages. The methods and systems provide automated process for content enlargement in documents based on user's eye power.

The methods and systems allow the user to enhance content of the document as per his requirement/choice, without requiring any manual effort/time for making any changes in text size. The content is enhanced such that it is compatible with the user visual lens power or reading vision/preference. The methods and systems allow the user to enhance content of the entire document or some specific pages of the document.

Although the disclosure is discussed wrt functionality at the multi-function device, but the disclosure can be implemented at a computing device of a user. For example, a print driver can: include the option visually enhanced content, store the visual lens power information, determine the visual lens power information if not available and allow the user to input the visual lens power information. The details are then sent to the multi-function device for printing. Before printing the document, the multi-function device enhances content of the document. Similarly, the disclosure can be implemented for scanning or copying scenarios.

The disclosure can be implemented for any individual or organizations. The disclosure can be used by anyone who has visual problems. In another example, the disclosure can be used by colleges, where students, teachers/professors depend on printed documents for work, assignments, or tasks as the enhanced content makes easy for them to read content/document. The methods and systems are flexible that allow the user to enhance content based on their choices/requirement.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, checking, enlarging, performing, printing, scanning, copying, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for enhancing content of a document according to visual lens power of a user, the method comprising:
receiving a document from a user for a pre-defined operation;
receiving a selection of a visually enhanced content option from the user;
based on the selection of the option, checking whether a profile of the user comprises visual lens power information of the user, wherein the visual lens power information of the user comprises visual lens power of at least one of left eye and right eye of the user;
based on the check, automatically enlarging the content of the document according to the visual lens power information of the user; and
generating an output document based on the pre-defined operation, comprising the enhanced content such that the enhanced content is comfortably readable for the user.

2. The method of claim 1, wherein the document received from the user is one of: a digital version of the document or a printed version of the document.

3. The method of claim 1, further comprising, enabling the visually enhanced content option for the user.

4. The method of claim 1, further comprising, receiving the visual lens power information from the user through a user interface.

5. The method of claim 1, further comprising, storing the profile of the user comprising the visual lens power information of the user.

6. The method of claim 1, wherein the profile of the user comprising at least one of: left eye power information, the right eye power information or readable content size.

7. The method of claim 1, further comprising, providing a user interface to the user to confirm whether the document is a public document or a personal document.

8. The method of claim 1, further comprising, automatically enhancing content of the document if the document is a personal document of the user.

9. The method of claim 1, further comprising, calculating a number of pages of the document, based on the content enhancement.

10. The method of claim 9, further comprising, allowing the user to enhance the content of the document based on one or more keywords.

11. The method of claim 10, further comprising, providing a user interface to the user to provide the one or more keywords for the content enhancement.

12. The method of claim 11, further comprising, identifying one or more pages having one or more matching keywords.

13. The method of claim 11, further comprising, enhancing content of the one or more identified pages having the one or more matching keywords.

14. The method of claim 1, further comprising, allowing the user to perform a visual lens power test at a multi-function device for visual power calibration.

15. The method of claim 14, further comprising, providing a user interface displaying a visual power test card for reading at least one of: the digital version and printed version of the document.

16. The method of claim 14, further comprising, providing a user interface displaying a survey test for the users input.

17. The method of claim 14, further comprising, generating a report for the user, based on a visual power test card and a survey test.

18. The method of claim 17, further comprising, allowing the user to perform at least one of: download the report, share the report, save the report or print the report.

19. The method of claim 1, further comprising, displaying one or more templates with different content sizes based on different visual lens power.

20. The method of claim 19, further comprising, storing a template in the user profile based on the selection of the template by the user for later retrieval and/or use.

21. A multi-function device for enhancing content of a document according to visual lens power of a user, the multi-function device comprising:
a receiver for receiving a document from a user for a pre-defined operation;
a user interface for receiving a selection of visually enhanced content option from the user; and
a controller for:
based on the selection, checking if a profile of the user comprises visual lens power information of the user, wherein the visual lens power information of the user comprises visual lens power of at least one of left eye and right eye of the user; and
based on the check, automatically enlarging the content of the document according to the visual lens power information of the user; and
requesting one of the following:
a print engine, a scanner, or a copier to generate an output document having the enhanced content such that the enhanced content is comfortable for the user.

22. The multi-function device of claim 21, wherein the controller is for receiving the visual lens power information from the user through a user interface.

23. The multi-function device of claim 21, wherein the controller is for creating and storing the profile of the user comprising the visual lens power information.

24. The multi-function device of claim 21, wherein the controller is for receiving whether the document is a public document or a personal document.

25. The multi-function device of claim 24, wherein the controller is for automatically enhancing content of the document according to the visual lens power information of the user, if the document is a personal document of the user.

26. The multi-function device of claim 21, wherein the controller is for calculating a number of pages of the document, based on the content enhancement.

27. The multi-function device of claim 21, wherein the controller is for allowing the user to enhance the content of the document based on one or more keywords.

28. The multi-function device of claim 21, wherein the user interface is for receiving the one or more keywords for the content enhancement.

29. The multi-function device of claim 28, wherein the controller is for identifying one or more pages having one or more matching keywords.

30. The multi-function device of claim 29, wherein the controller is for enhancing content of the one or more identified pages having the one or more matching keywords.

31. The multi-function device of claim 21, wherein the controller is for allowing the user to perform a visual lens power test at the multi-function device for visual power calibration based on a visual power test card and a survey test.

32. The multi-function device of claim 31, wherein the controller is for generating a report for the user, based on the visual power test card and the survey test.

33. A system for enhancing content of a document according to visual lens power of a user, the system comprising:
a server for:
receiving a document along with a selection of visually enhanced content option;
based on the selection, checking if a profile of the user comprises visual lens power information of the user, wherein the visual lens power information of the user comprises visual lens power of at least one of left eye and right eye of the user;
based on the check, automatically enlarging the content of the document according to the visual lens power information of the user; and
sending the document comprising the enhanced content of the document to a multi-function device for further processing; and
the multi-function device communicatively coupled to the server for generating an output document comprising the enhanced content such that the enhanced content is comfortably readable by the user.
